(19) United States
(12) Patent Application Publication
(10) Pub. No.: US 2025/0123170 A1
(43) Pub. Date: Apr. 17, 2025

(54) NON-METALLIC ISOLATOR SYSTEMS FOR INDUSTRIAL PROCESS PRESSURE TRANSMITTERS

(71) Applicant: Rosemount Inc., Shakopee, MN (US)

(72) Inventors: Nicholas Meyer, Victoria, MN (US); Jacob D. Holm, Savage, MN (US); Eric Petersen, Minnetonka, MN (US)

(21) Appl. No.: 18/915,861

(22) Filed: Oct. 15, 2024

Related U.S. Application Data
(60) Provisional application No. 63/590,574, filed on Oct. 16, 2023.

(51) Int. Cl. G01L 19/06

(52) U.S. Cl. CPC G01L 19/0645

(57) ABSTRACT

A pressure transmitter includes a process connector configured to mount to a process vessel that carries a process fluid, a process pressure sensor and an isolator plug coupled to the process connector and configured to house the process pressure sensor. The isolator plug includes at least one internal fluid filled cavity that is in fluidic contact with the process pressure sensor. At least one transfer mount made of a metallic material is coupled to the isolator plug. The transfer mount includes an internal fluid filled cavity that is in fluid communication with the internal fluid filled cavity of the isolator plug. At least one isolation diaphragm exposed to the process fluid in the process connector is coupled to the transfer mount and configured to transfer process pressure to the internal fluid filled cavities of the transfer mount and the isolator plug and to the process pressure sensor.

### CROSS-REFERENCE TO RELATED APPLICATION

The present application is based on and claims the benefit of U.S. provisional patent application Ser. No. 63/590,574, filed Oct. 16, 2023, the content of which is hereby incorporated by reference in its entirety.

### BACKGROUND

The present invention relates to process variable transmitters of the type used to sense process pressures. Most particularly, the invention relates to a non-metallic or metalloid isolation diaphragm for coupling such pressure transmitters to a pressure of an industrial process.

Typically, metal isolation diaphragms are used to couple pressures sensors to process pressures. Such diaphragms can accurately couple the process pressure to an isolated fill fluid which conveys the pressure to the pressure sensor. Metal diaphragms can withstand impact and other disturbances without rupturing. However, in some industrial processes, the process fluid can erode the metal diaphragm or otherwise lead to the ultimate failure of the diaphragm.

Ceramic diaphragms have been used with process fluids that can erode a metal diaphragm. However, it is difficult to couple a ceramic diaphragm to the transmitter housing.

### SUMMARY

A pressure transmitter includes a process connector configured to mount to a process vessel that carries a process fluid, a process pressure sensor and an isolator plug coupled to the process connector and configured to house the process pressure sensor. The isolator plug includes an internal fluid filled cavity that is in fluidic contact with the process pressure sensor. A transfer mount made of a metallic material is coupled to the isolator plug. The transfer mount includes an internal fluid filled cavity that is in fluid communication with the internal fluid filled cavity of the isolator plug. An isolation diaphragm exposed to the process fluid in the process connector is coupled to the transfer mount and configured to transfer process pressure to the internal fluid filled cavities of the transfer mount and the isolator plug and to the process pressure sensor. The isolation diaphragm comprises a non-metallic material or a metalloid material.

A pressure transmitter includes a process connector configured to mount to a process vessel that carries a process fluid, a process pressure sensor and an isolator plug coupled to the process connector and configured to house the process pressure sensor. The isolator plug includes an internal fluid filled cavity that is in fluidic contact with the process pressure sensor. A transfer mount made of a metallic material is coupled to the isolator plug. The transfer mount includes an internal fluid filled cavity that is in fluid communication with the internal fluid filled cavity of the isolator plug. A non-metallic assembly is coupled to the transfer mount and includes a pedestal made of a non-metallic material and an isolation diaphragm made of a non-metallic material that is exposed to the process fluid in the process connector and coupled to the pedestal. The pedestal comprises an internal fluid filled cavity that is in fluid communication with the internal fluid filled cavities of the transfer mount and the isolator plug.

A pressure transmitter includes a process connector configured to mount to a process vessel that carries a process fluid, a process pressure sensor and an isolator plug coupled to the process connector and configured to house the process pressure sensor. The isolator plug includes an internal fluid filled cavity that is in fluidic contact with the process pressure sensor. A spacer is coupled to the isolator plug and comprises an internal fluid filled cavity that is in fluid communication with the internal fluid filled cavity of the isolator plug. A transfer mount made of a metallic material is coupled to the spacer. The transfer mount includes an internal fluid filled cavity that is in fluid communication with the internal fluid filled cavities of the spacer and the isolator plug. A non-metallic assembly is coupled to the transfer mount and includes a pedestal made of a non-metallic material and an isolation diaphragm made of a non-metallic material that is exposed to the process fluid in the process connector and coupled to the pedestal. The pedestal comprises an internal fluid filled cavity that is in fluid communication with the internal fluid filled cavities of the transfer mount, the spacer and the isolator plug.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1a illustrates a simplified section view of a sensor capsule that uses an in-line gage pressure sensor for in-line applications.

FIG. 1b illustrates a simplified section view of a sensor capsule that uses a differential pressure sensor for coplanar applications.

FIG. 2 illustrates a perspective view of an in-line pressure transmitter that includes a non-metallic isolator system according to an embodiment.

FIG. 3 illustrates an enlarged perspective view of a sensor module and a process connector of the processor transmitter of FIG. 2.

FIG. 4 illustrates a section view taken through the section line illustrated in FIG. 3.

FIG. 5 illustrates an exploded perspective view of FIG. 4.

FIG. 6 is a graph of coefficients of thermal expansion for various metallic materials versus temperature.

FIG. 7 illustrates a section view of a sensor capsule and a process connector of a process transmitter that includes a non-metallic isolator system according to an embodiment.

FIG. 8 illustrates an exploded view of FIG. 7.

FIG. 9 illustrates a simplified diagram of a section view of a portion of an in-line pressure transmitter that includes a non-metallic isolator system according to an embodiment.

FIG. 10 is a table showing a galvanic series in sea water.

FIG. 11 is a simplified diagram of a section view of portions of an in-line pressure transmitter that includes a non-metallic isolator system according to an embodiment.

FIG. 12 is a simplified diagram of a section view of a portion of the non-metallic isolator system of FIG. 11 including a gasket according to an embodiment.

FIG. 13 is a simplified diagram of a section view of a portion of an in-line pressure transmitter that includes a non-metallic isolator system according to an embodiment.

FIG. 14 is a simplified diagram of a section view of a portion of an in-line pressure transmitter that includes an isolator system according to an embodiment.

FIG. 15 illustrates a perspective view of a silicon isolation diaphragm as used in the isolator system of FIG. 14.

FIG. 16 is a simplified diagram of a strain gauge sensor of the in-line pressure transmitter of FIG. 14.

FIG. 17 is a simplified diagram of a section view of a portion of a differential pressure transmitter that includes a non-metallic isolator system according to an embodiment.

FIG. 18 is a simplified diagram of a section view of a portion of a differential pressure transmitter that includes a non-metallic isolator system according to an embodiment.

### DETAILED DESCRIPTION OF ILLUSTRATIVE EMBODIMENTS

Embodiments of non-metallic isolator systems and associated mounting systems are described below and allow for fluid filled systems, such as oil filled systems, that use existing sensor technology and configurations but offer a non-metallic process wetted diaphragm for harsh applications. The benefits of non-metallic isolator diaphragms include abrasion resistance, corrosion resistance, resistance to hydrogen permeation, with the benefits of existing sensor technology including accuracy, repeatability, drift performance, overpressure protection, and rangeability. Additionally, some embodiments mitigate the need for a wetted O-ring that is typically used with ceramic diaphragms. The embodiments are related to inline pressure transmitters however embodiments may also be used in differential pressure transmitters.

The process conditions that can be better served by non-metallic diaphragms are highly corrosive processes, highly abrasive processes, and those with a risk of hydrogen permeation. Hydrogen permeation is the diffusion of hydrogen ions through isolation diaphragms used in a pressure transmitter either through interstitial or substitutional (vacancy) mechanisms. Over time, the fill fluid becomes saturated, and hydrogen bubbles form. If enough hydrogen bubbles form, the zero and span shifts cause the transmitter to drift. In extreme cases, the hydrogen bubbles can build enough volume to force the isolation diaphragm to expand outward causing cracking of the diaphragm, which leads to leakage of the fill fluid into the process fluid and failure of the pressure transmitter.

A typical metallic diaphragm may be 0.001-0.002″ thick and a single metal defect can result in pitting (corrosion). One impact on the defect can puncture the metal (rupture), and monoatomic hydrogen can eventually find its way through the metal lattice structure (permeation). Typical solutions such as coatings or platings will improve resistance to hydrogen permeation but are costly and sacrifice device accuracy and temperature performance.

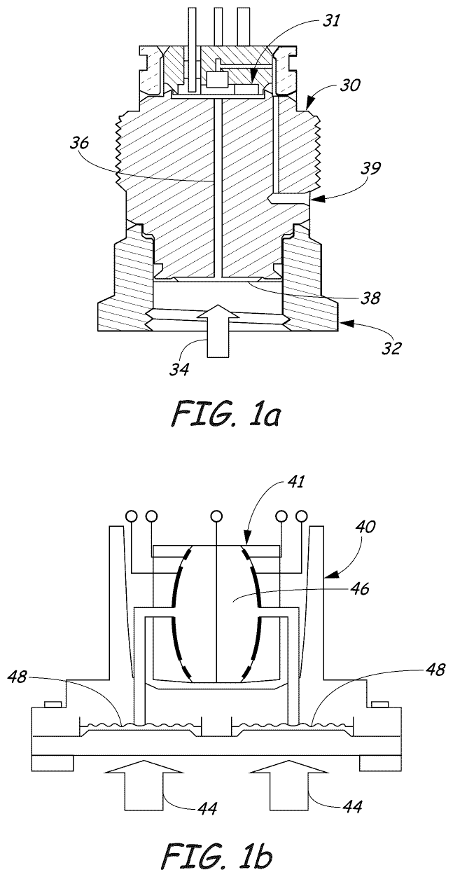

Embodiments of this disclosure include a non-metallic isolator system that can operate with existing sensor technology, such as existing sensors and sensor capsules in sensor module housings. For example, FIG. 1a illustrates a simplified section view of a conventional sensor capsule 30 and process connector 32 that uses a gage pressure sensor 31 for inline applications. In another example, FIG. 1b illustrates a simplified section view of a conventional sensor capsule 40 that uses a differential pressure sensor 41 for coplanar applications. In a typical in-line application as shown in FIG. 1a, sensor capsule 30 includes isolator diaphragm 38 that is exposed to and isolates process fluid pressure 34 from fill fluid 36 and gage pressure sensor 31. For example, fill fluid 36 may be an oil or other fluid. Sensor capsule 30 further includes a gage pressure vent 39 so that high pressure exists between isolator diaphragm 38 and sensor 31 and a low pressure exists between sensor 31 and vent 39. In a typical coplanar application as shown in FIG. 1b, sensor capsule 40 includes a pair of isolator diaphragms 47 and 48 that are exposed to and isolate process fluid pressure 44 from fill fluid 46 in a fluid filled cavity and differential pressure sensor 41.

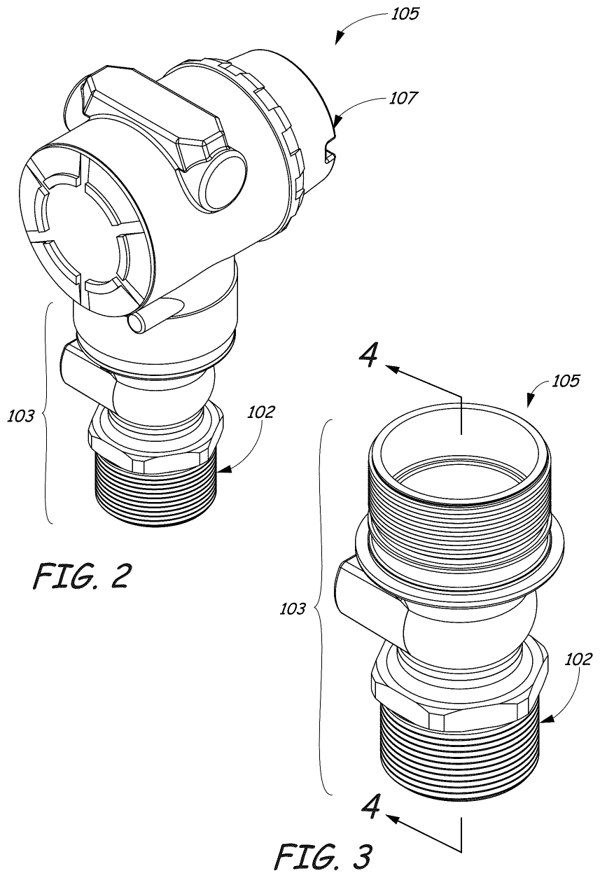

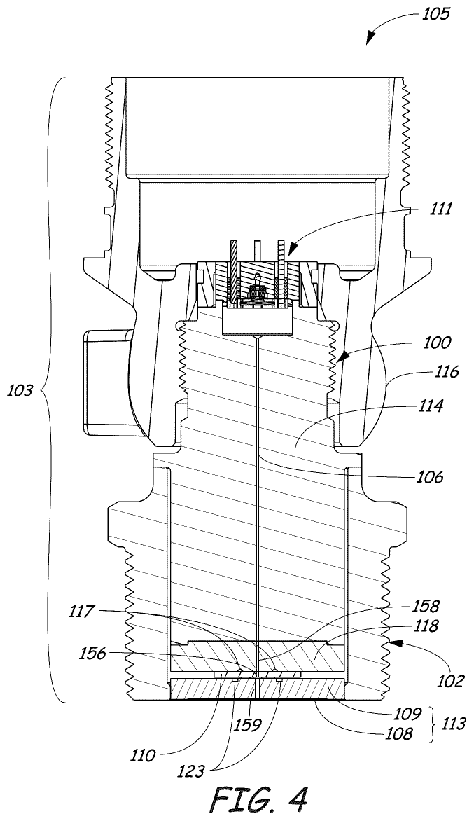

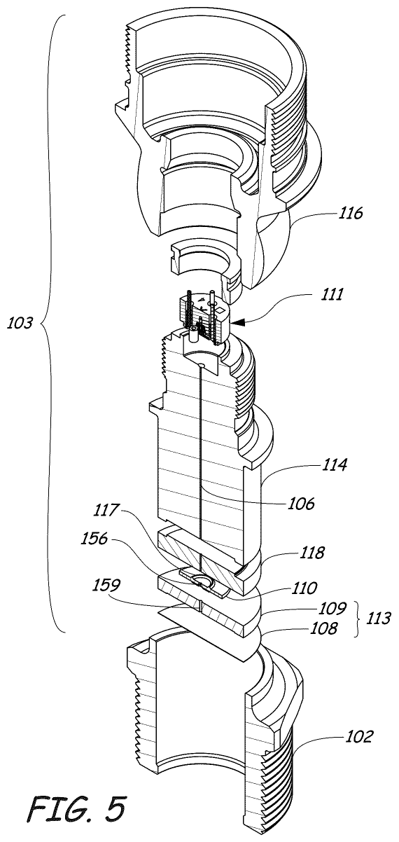

FIG. 2 illustrates a perspective view of an in-line pressure transmitter 105 that includes a non-metallic isolator system according to an embodiment. Pressure transmitter 105 includes a process connector 102, a sensor module 103 having a sensor capsule (not illustrated in FIG. 2) and electronics 107. FIG. 3 illustrates an enlarged perspective view of sensor module 103 and process connector 102 of processor transmitter 105, FIG. 4 illustrates a section view taken through the section line illustrated in FIG. 3 and FIG. 5 illustrates an exploded perspective view of FIG. 4. Process connector 102 is configured to mount to a process vessel that carries a process fluid. Sensor module 103 includes a process pressure sensor 111 and an isolator plug 114 coupled to processor connector 102 and configured to house process pressure sensor 111. In FIG. 3, sensor 111 may be a gage pressure sensor. Isolator plug 114 includes an internal fluid filled cavity 106 that is in fluidic contact with process pressure sensor 111. For example, fluid in fluid filled cavity 106 may be oil.

Under one embodiment, pressure transmitter 105 includes an isolator diaphragm 108 made of a non-metallic material and coupled to a transfer mount 110 made of a metallic material, which in turn is coupled to isolator plug 114. Isolator diaphragm 108 is a thin member that is exposed to the process fluid in process connector 102 and is configured to transfer process pressure to internal fluid or fluid filled cavity 106 of isolator plug 114 and needs to be flexible enough to accommodate the expansion and contraction of the fill fluid over temperature changes but also at high pressures. For example, isolator diaphragm 108 may be made of ceramic, such as a transparent ceramic like single-crystal aluminum oxide or sapphire, alumina, Zirconia, or Zirconia Toughened Alumina (ZTA) and may be diffusion bonded to a pedestal 109 also made of a non-metallic material. For example, pedestal 109 may be made of a ceramic, such as alumina, and together with isolation diaphragm 108 forms a non-metallic assembly 113. Pedestal 109 couples isolation diaphragm 108 to transfer mount 110.

A conventional isolator plug 114, such as a stainless steel isolator plug, may be used to interface with process pressure sensor 111 and housing 116 of sensor module 103. As illustrated in FIGS. 4 and 5, isolator plug 114 may have an extended length to allow for male threaded connections to housing 116 of sensor module 104 and attachment to process connector 102. For example, process connector 102 may attach to isolator plug 114 by weld-on, thread-on or bolt-on connections.

Transfer mount 110 includes an internal fluid or fluid filled cavity 156 that is in fluid communication with internal fluid filled cavity 106 of isolator plug 114. Pedestal 109 includes an internal fluid or fluid filled cavity 159 that is in fluid communication with internal fluid filled cavity 156 of transfer mount 110 and internal fluid filled cavity 106 of isolator plug 114. Therefore, isolation diaphragm 108 is configured to transfer process pressure to internal fluid filled cavity 156 of transfer mount 110 and internal fluid filled cavity 106 of isolator plug 114 and ultimately to process pressure sensor 111.

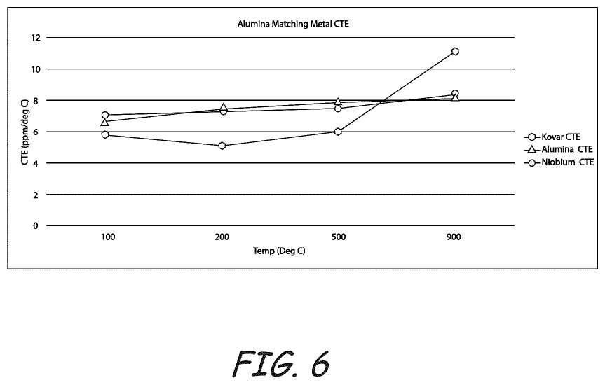

FIG. 6 is a graph of coefficient of thermal expansion (CTE) values for various metallic materials versus temperature. Transfer mount 110 may be made of a metallic material, such as tantalum, niobium, Kovar or Invar that has a CTE that is close to a CTE of a non-metallic material that pedestal 109 and isolation diaphragm 108 are made of. For example and as illustrated in FIG. 6, each metallic material includes a CTE at different temperatures. Each of those CTE values intersect with the non-metallic material of alumina at least once. Therefore, any of tantalum, niobium, Kovar, Inver, alloy 42, alloy 46 or alloy 52 are close to a CTE of the non-metallic material of alumina and are possible material selections for transfer mount 110. In other words, the metallic material of transfer mount 110 includes a CTE that has a range of CTE values (y-axis) that overlap with a range of CTE values (y-axis) of the non-metallic material of pedestal 109 and/or isolation diaphragm 109. For example, metallic mount 110 may be made of tantalum or niobium which have CTEs that substantially match or are close to CTEs of alumina of non-metallic body 109.

Non-metallic assembly 113, or more particularly, pedestal 109 of non-metallic assembly 113, may be coupled to transfer mount 110 by, for example, solder, braze or glass. The joint that couples non-metallic assembly 113 to metallic mount 110 should have high corrosion resistance and withstand high temperatures. One example includes a solder 123, such as 80Au/20Sn solder. Opposite to the joint to non-metallic assembly 113 is a projection feature 117 of metallic mount 110, which will be discussed below in more detail.

A spacer 118 links non-metallic assembly 113 and transfer mount 110 to isolator plug 114 and may be provided to relieve the stress on pedestal 109. Projection feature 117 of metallic mount 110 allows for the projection welding or soldering of spacer 118 to metallic mount 110. In addition, spacer 118 may be laser welded to isolator plug 114 and may be made of a material resistant to pitting and crevice corrosion and have a CTE that is close to the CTE of metallic mount 110. For example, spacer 118 may be made of a nickel alloy, such as C-276, which is a nickel-chromium-molybdenum alloy. Spacer 118 includes an internal fluid filled cavity 158 that is in fluidic communication with internal fluid filled cavity 159 of pedestal 109, internal fluid filled cavity 156 of transfer mount 110 and internal fluid filled cavity 106 of isolator plug 114.

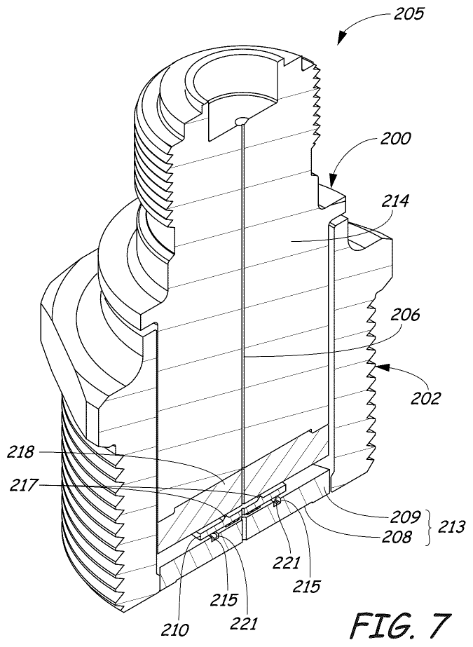

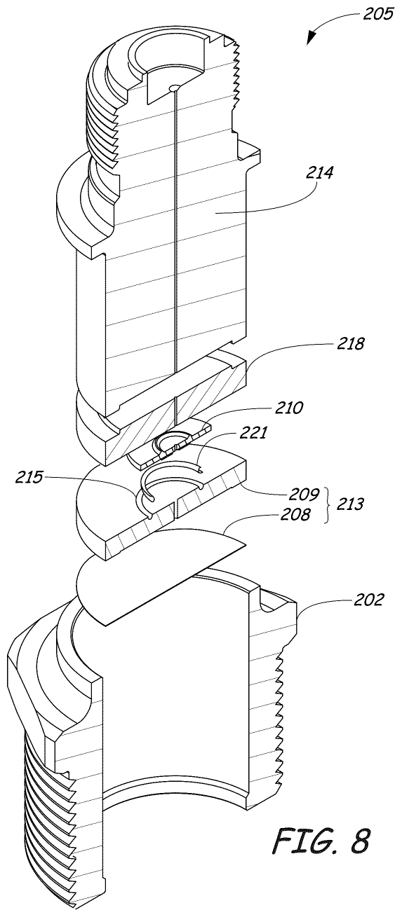

In other embodiments. a gasket is utilized to mitigate corrosion between joints. For example, FIG. 7 illustrates a section view of a sensor capsule 200 and a process connector 202 of a process transmitter 205 that includes a non-metallic isolator system according to an embodiment. FIG. 8 illustrates an exploded view of FIG. 7. Under one embodiment, sensor capsule 200 includes a non-metallic isolator diaphragm 208 and a non-metallic pedestal 209 bonded to a metallic transfer mount 210 that is attached to a sensor (not illustrated). Non-metallic isolator diaphragm 208 is a thin member that transfers process pressure to the internal fluid, such as oil, or fluid filled cavity 206 and needs to be flexible enough to accommodate the expansion and contraction of the fluid fill over temperature changes but also at high pressures. For example, non-metallic isolator diaphragm 208 may be made of ceramic, such as a transparent ceramic like single-crystal aluminum oxide or sapphire, alumina, Zirconia, or Zirconia Toughened Alumina (ZTA) and may be diffusion bonded to non-metallic pedestal 209, which may be made of a ceramic, such as alumina, to form a non-metallic assembly 213.

A conventional isolator plug or sensor housing adaptor 214, such as a stainless steel isolator plug, may be used to interface with the sensor and housing (not illustrated) of sensor capsule 200. As illustrated in FIGS. 7 and 8, isolator plug 214 may have an extended length to allow for male threaded connections to the housing of sensor capsule 200 and attachment to process connector 202. For example, process connector 202 may attach to isolator plug 214 by weld-on, thread-on or bolt-on connections.

Metallic transfer mount 210 is joined to non-metallic assembly 213 by for example, solder, braze or glassing. Metallic transfer mount 210 should be made of a material that has a coefficient of thermal expansion (CTE) that overlaps the material of non-metallic pedestal 209 and isolation diaphragm 208. For example, metallic transfer mount 110 may be made of tantalum or niobium, which have CTEs that overlap, for example, alumina of non-metallic pedestal 209. The joint that couples non-metallic assembly 213 to metallic transfer mount 210 should have high corrosion resistance and withstand high temperatures. One example includes a solder, such as 80Au/20Sn solder.

Pursuant to this embodiment, a spacer 218 links non-metallic assembly 213 and metallic transfer mount 210 to isolator plug 214 and may be provided to relieve the stress on non-metallic body 209. Metallic mount 210 may include a projection feature 217. Projection feature 217 allows for the projection welding or soldering of spacer 218 to metallic transfer mount 210. In addition, spacer 218 may be laser welded to isolator plug 214 and may be made of a material resistant to pitting and crevice corrosion and have a CTE that overlaps the CTE of metallic transfer mount 210. For example, spacer 218 may be made of a nickel alloy, such as C-276, which is a nickel-chromium-molybdenum alloy.

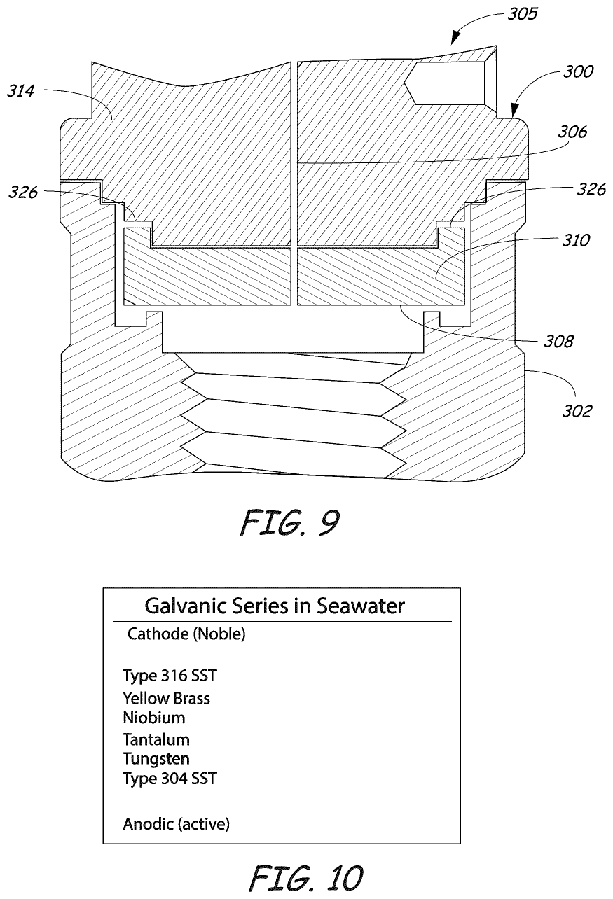

In this embodiment, non-metallic pedestal 209 includes a groove 215 that faces metallic transfer mount 210. Groove 215 is configured to receive and house a gasket 221. In FIGS. 8 and 9, gasket 221 is a C-ring gasket. C-ring gasket 221 prevents wetting between non-metallic assembly 213 and metallic transfer mount 210 and protects the bonding or joint area between non-metallic assembly 213 and metallic transfer mount 210. C-ring gasket 221 is useful if solder, braze or glassing is used to join non-metallic assembly 213 to metallic mount 210, however, other gasket types are possible including an O-ring gasket made of a polymeric material.

FIG. 9 illustrates a simplified diagram of a section view of a portion of sensor capsule 300 and processor connector 302 of an in-line pressure transmitter 305 that includes a non-metallic isolator system according to another embodiment. Sensor capsule 300 includes an isolator plug 314 made of, for example, stainless steel, a metallic transfer mount 310, made for example of niobium and a non-metallic isolation diaphragm 308, made for example, of ceramic. Non-metallic isolation diaphragm 308 is a thin member that transfers process pressure to the internal fluid, such as oil, or fluid filled cavity 306 of sensor capsule 300 and may be made of ceramic, such as alumina, single crystal sapphire, Zirconia, or Zirconia Toughened Alumina (ZTA). Diaphragm 308 needs to be flexible enough to deflect primarily over temperature changes but also at high pressures up to and beyond 20,000 PSI for example, and the stroke necessary to accommodate the expansion and contraction of the fluid filled system over a range of temperatures. Non-metallic isolation diaphragm 308 is attached to metallic transfer mount 310. In the case where metallic mount 310 is made of niobium, niobium is a refractory metal that provides an excellent CTE match or overlap with alumina ceramics, as shown in FIG. 6. As such, stresses from the CTE mismatch are essentially eliminated.

Further metallic transfer mount 310 made of niobium may be directly bonded to ceramic via pressure bonding or diffusion bonding. Heat and pressure applied to a niobium-alumina assembly results in solid-state diffusion bond where the alumina (Al₂O₃) and niobium (Nb) share an oxide layer. This results in an extremely strong bond between the ceramic and niobium, which eliminates the risk of a braze joint and the need for a gasket. The niobium-ceramic joint shares an oxide and may be directly wetted in the process. Niobium itself has excellent corrosion resistance. Niobium can experience hydrogen permeation but in FIG. 9, metallic transfer mount 310 is a thick member under minimal compressive load and is not at risk of material failure. The ASM Handbook for Corrosion of Specialty Metals (13B) discusses niobium and galvanic coupling effects: “Niobium is susceptible to hydrogen embrittlement if it is polarized cathodically by galvanic coupling. However, if niobium is polarized anodically, it forms a very stable passive film that protects the metal from corrosion.” As illustrated in the FIG. 10 table, niobium falls between 304 SST and 316 SST on the galvanic series. Therefore, a metallic transfer mount 310 made of niobium and being attached to a 316L stainless steel isolator plug will be polarized anodically and therefore protected from hydrogen embrittlement and corrosion. Therefore, a gasket will not be required, and all components may be wetted. Metallic transfer mount 310 is joined to isolator plug 314 by, for example, a weld or braze 326. However, other types of joining are possible.

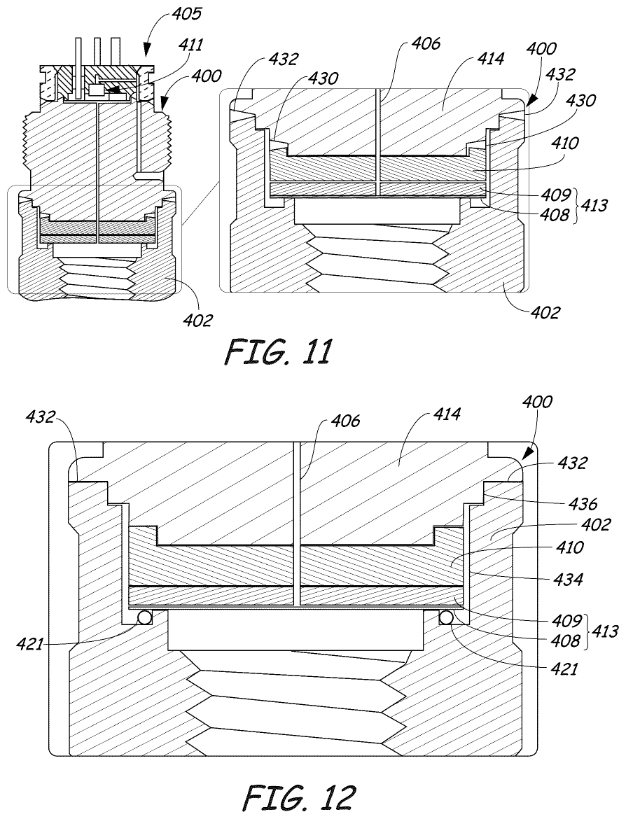

FIG. 11 is a simplified diagram of a section view of a portion of sensor capsule 400 and process connector 402 of an in-line pressure transmitter 405 that includes a non-metallic isolator system according to an embodiment. Sensor capsule 400 includes four main components: 1) a ceramic isolation diaphragm 408; 2) a ceramic pedestal 409; 3) a metallic transfer mount 410 made, for example, of Kovar; and 4) an isolator plug 414 made, for example, of 316L stainless steel. The concepts of this design are similar to the niobium-ceramic design of FIG. 9, but this design includes braze joints and may include an O-ring or gasket to protect the braze joints from corrosion.

In FIG. 11, process connector 402 is welded to isolator plug at 432. Ceramic isolation diaphragm 408 is again a thin member that must deflect over temperatures and pressures. Finite Element Analysis (FEA) has shown ceramic diaphragm 408 is not damaged by the deflection and stresses imparted. Ceramic isolation diaphragm 408 is either brazed or glassed onto ceramic pedestal 409. Both isolation diaphragm 408 and pedestal 409 would be metallized on one side to allow for a braze joint.

Pedestal 409 is a relatively thin disk of ceramic that is metallized on both sides. The metallization allows brazing to attach pedestal 409 to isolation diaphragm 408 on one side and attach to the metallic transfer mount 410 on the other. The purpose of pedestal 409 is to isolate stresses from CTE mismatches. CTE differences of the dissimilar materials in the assembly will stress the components and the joints and can cause failures. The matched materials of pedestal 409 and isolation diaphragm 408 avoid concentrating those stresses in isolator 408 or in the diaphragm-pedestal joint. This improves performance by allowing for a thinner isolation diaphragm 408 and limiting the burn-in time required to relax and stabilize joints. The isolation diaphragm 408 and pedestal 408 may be obtained as an assembly 413 or may be provided as components and brazed (or glassed) together. This diaphragm-pedestal assembly 413 is then attached to metallic mount 410 via brazing.

Metallic transfer mount 410 is a machined disk with the purpose of linking the non-metallic diaphragm 408 and pedestal 409 to isolator plug 414, which holds a sensor 411. Kovar and ceramic are a close CTE match which makes Kovar a good choice for joining to ceramic. The close CTE match minimizes stresses in the assembly. Niobium may also be chosen for metallic transfer mount 410. The metallic transfer mount 410, such as Kovar or niobium, is then welded at 430 to the stainless-steel isolator plug 414. Metallic transfer mount 410 could also be brazed at 430 to plug 414.

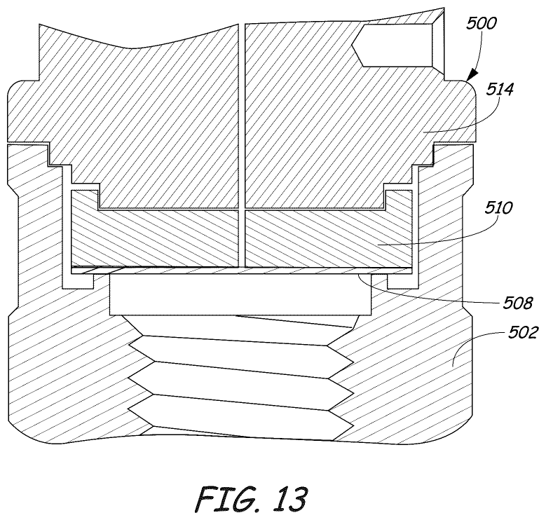

FIG. 12 is a simplified diagram of a section view of the portion of the non-metallic isolator system of FIG. 11 but also includes a gasket 421 according to an embodiment. For example, gasket 421 may be an O-ring as shown in FIG. 13. One reason an O-ring may be included is because of the Kovar metallic mount 410 and stainless steel isolator plug 414 pairing. Kovar is toward the active end of a galvanic series and stainless steel is on the passive end. Directly joining these two materials creates a galvanic coupling. If such a joint were wetted, it would activate the galvanic cell and may lead to deterioration of the Kovar (being least noble). To protect the joint from corrosive environments, coating or plating the cover may offer protection and remove the need to keep the joint dry from process. Another reason for the O-ring is to protect the braze joints. Brazes can be susceptible to corrosion. Good braze material selection may mitigate issues and negate the need for an O-ring.

O-ring 421 has been designed with some unique characteristics to ensure success in the assembly. First, in FIG. 12, the consequence of O-ring failure is much less severe. This is because the process fluid would still be contained between isolator plug 414 and process connector 402. Over time, process fluid in the thin gap 434 may occur between process connector 402 and metallic transfer mount 410 and ceramic pedestal 409 and may cause corrosion of braze joints or galvanic corrosion between the dissimilar materials. However, O-ring 421 would prevent a breach of fluid filled cavity 406 and fluid loss. Another feature of O-ring 421 is that it is designed to minimize or eliminate potential for gasket creep by including a flow barrier and centering feature. Centering feature 436 maintains a thin gap 434. However, one wall of the gland of O-ring 421 acts as a flow barrier with gap 434. These features prevent O-ring extrusion at high pressures. The flow barrier works to force the O-ring into the corners and energizes it in a way that makes the seal stronger with increased pressure.

FIG. 13 is a simplified diagram of a section view of a portion of a sensor capsule 500 and a process connector 502 of an in-line pressure transmitter 505 that includes a non-metallic isolator system according to an embodiment. A simplified Kovar-ceramic-ceramic system is shown in FIG. 13 in which a ceramic pedestal is eliminated. In this configuration isolation diaphragm 508 is attached directly to metallic mount 510, which may be made of Kovar. Kovar and ceramic CTE match well over a limited temperature range. The brazing process or braze joint to attach isolation diaphragm 508 to the Kovar would result in weld pre-tensioning due to the higher CTE differences. This would be beneficial to reduce isolator effects and non-linearities that can occur when an isolation diaphragm crosses the zero plane.

A diaphragm system can also use crystalline silicon as the diaphragm material instead of a ceramic. Crystalline silicon is a metalloid (neither a metal or a non-metal) and inert. Most acids do not affect metalloids which would make it a good choice as a process wetted material. Silicon has high tensile and compressive strength. Additionally, single crystal silicon has a 2.5 times lower Young's Modulus (stiffness) compared to ceramic, such as alumina. This is beneficial, as a silicon diaphragm will have greater deflection for the same pressure level compared to ceramic, reducing isolator effects on sensor performance. Additionally, for the same deflection level, a silicon diaphragm will have a lower stress level compared to ceramic, increasing margin of safety for robustness.

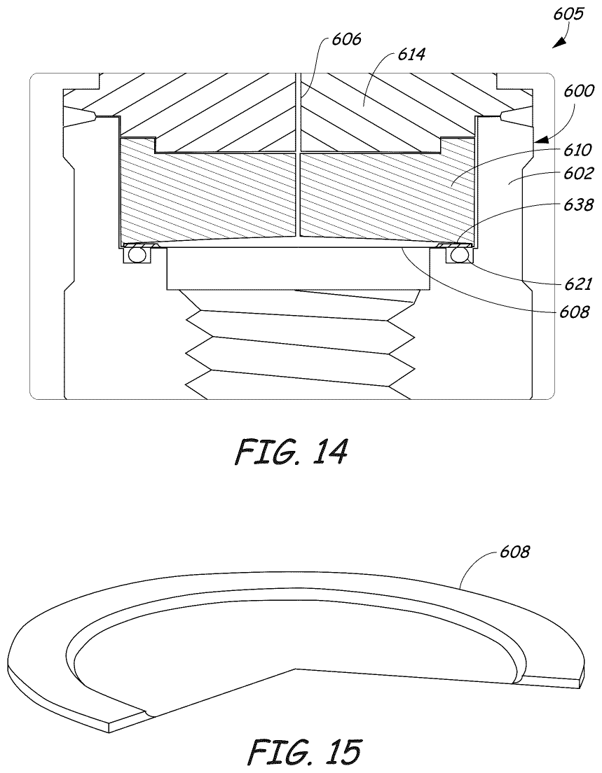

One example design of such a configuration is shown in FIGS. 14-16. FIG. 14 is a simplified diagram of a section view of a portion of a sensor capsule 600 and a process connector 602 of an in-line pressure transmitter 605 that includes a silicon isolator system according to an embodiment. FIG. 15 illustrates a perspective view of silicon isolation diaphragm 608, which is included in sensor capsule 600 of FIG. 14. Silicon isolation diaphragm 608 may be metallized on one side and brazed onto a metallic transfer mount 610 made, for example, of Kovar (or Niobium). The silicon isolation diaphragm 608 is thicker at a braze joint 638 and etched in the fluid filled cavity 606 for better flexibility.

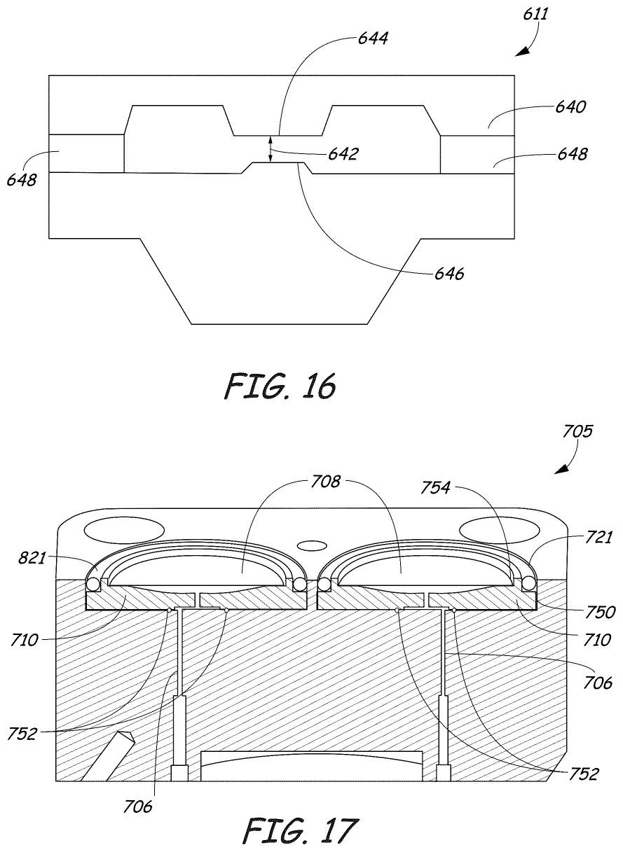

The embodiment illustrated in FIGS. 14 and 15 will project the hinge point out into the thin diaphragm 608 which has better flexural strength and it moves stress away from brazed joint 638 between the Kovar and the silicon. FIG. 16 illustrates a simplified, not to scale, diagram of a strain gauge sensor 611 that is housed by sensor capsule 600. Strain gauge sensor 611 may be made of silicon and sculpted using isotropic and anisotropic etching with overpressure stops 640 to protect the isolation diaphragm 608 from rupturing in overpressure conditions. FIG. 16 illustrates a gap 642 located between a boss 644 and a mesa 646. Frits 648 are located on either side of gap 642. This would also work to reduce the fluid volume and improve performance.

Metallic mount 610 made of niobium and Kovar may be interchangeable. Embodiments can be implemented using either material as both are a good choice for CTE match to silicon. In addition, sensor capsule may include a gasket or O-ring 621 for the issues previously discussed in other embodiments.

As is the case in the embodiments illustrated in FIGS. 2-5 and 6-8, tantalum can replace niobium in the above assemblies because it also has a close CTE match to alumina. While tantalum offers a much more difficult and intensive manufacturing process because tantalum cannot directly bond with ceramic through diffusion bonding, and a braze would be required for a tantalum-ceramic joint, a braze may be used for bonding the tantalum to stainless steel body of the isolator plug.

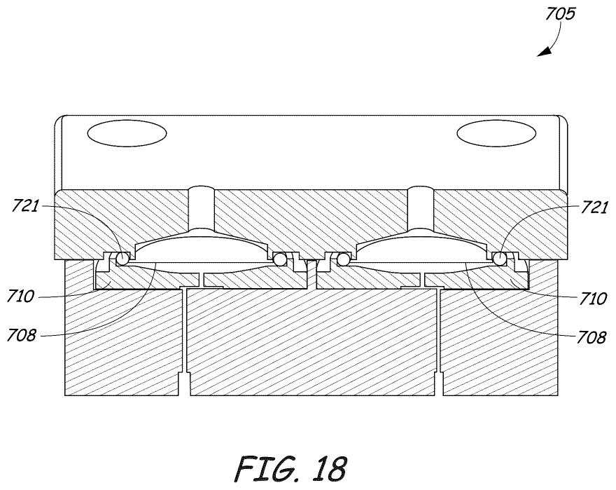

The concepts of the inline systems disclosed herein can be used in a coplanar differential pressure measurement system, such as a coplanar differential system of FIG. 1b. A coplanar system brings additional challenges of isolation diaphragm stroke, but larger isolation diaphragms can offer better flexural properties to address those issues. FIGS. 17 and 18 illustrate an embodiment of a coplanar non-metallic isolator system in a coplanar differential pressure measurement system 705. Ceramic isolation diaphragms 708 are each brazed onto a metallic transfer mount 710 made, for example, of Kovar, and acts as a subassembly. The Kovar transfer mount 710 is either brazed or welded into a slightly modified module casting. This is the same module casting but without a machined convolution pattern and only includes a pocket. The weld joint 750 can be laser, TIG, spin weld, or a projection weld 752. A projection weld can help seal the fluid filled cavity 706 near the inlet from the module housing. This would be ideal to minimize fluid volume. Coplanar differential pressure measurement system 705 includes O-ring 721 on the module that leaves a braze joint 754 and the Kovar exposed to process fluid. In another design, the O-ring 721 is placed onto the process flange and sealed directly against the ceramic diaphragm.

The design can also be used with a “remote seal” configuration in which the non-metallic isolation diaphragm is located remotely from the sensor and coupled to the transmitter using fluid filled impulse piping. In a “remote seal” application, a process connector can include overpressure stops to protect the diaphragm from rupturing in vacuum or due to fluid expansion. An O-ring may not need to be a polymer or sealing member but can provide mechanical compression to the assembly. This potentially unlocks higher line pressures, or higher temperatures because it supports the assembly joints.

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Although the present invention has been described with reference to preferred embodiments, workers skilled in the art will recognize that changes may be made in form and detail without departing from the spirit and scope of the invention. The non-metallic isolator diaphragm can be fabricated of any suitable material including alumina, single crystal sapphire. Zirconia, or Zirconia Toughened Alumina (ZTA), single crystal silicon, silicon nitride or silicon carbide.

What is claimed is:

1. A pressure transmitter comprising:
a process connector configured to mount to a process vessel that carries a process fluid;
a process pressure sensor;
an isolator plug coupled to the process connector and configured to house the process pressure sensor, wherein the isolator plug includes at least one internal fluid filled cavity that is in fluidic contact with the process pressure sensor;
at least one transfer mount made of a metallic material and being coupled to the isolator plug, wherein the at least one transfer mount includes an internal fluid filled cavity that is in fluid communication with the at least one internal fluid filled cavity of the isolator plug; and
at least one isolation diaphragm exposed to the process fluid in the process connector and coupled to the at least one transfer mount, the at least one isolation diaphragm configured to transfer process pressure to the internal fluid filled cavities of the transfer mount and the isolator plug and to the process pressure sensor, wherein the at least one isolation diaphragm comprises a non-metallic material or a metalloid material.

2. The pressure transmitter of claim 1, wherein the material of the at least one isolator diaphragm is the non-metallic material and comprises alumina, single crystal sapphire, Zirconia, or Zirconia Toughened Alumina (ZTA).

3. The pressure transmitter of claim 1, wherein the material of the at least one isolator diaphragm is the metalloid material and the metalloid material of the isolator diaphragm comprises single crystal silicon, silicon nitride or silicon carbide.

4. The pressure transmitter of claim 1, wherein the metallic material of the at least one transfer mount includes a coefficient of thermal expansion that comprises a range of values that overlap with a range of values of a coefficient of thermal expansion of the non-metallic material of the at least one isolation diaphragm.

5. The pressure transmitter of claim 4, wherein the metallic material of the at least one transfer mount comprises tantalum, niobium, Kovar, Invar, alloy 42, alloy 46 or alloy 52.

6. The pressure transmitter of claim 1, further comprising at least one pedestal made of a non-metallic material that couples the at least one isolation diaphragm to the at least one transfer mount, wherein the at least one pedestal comprises an internal fluid filled cavity that is in fluid communication with the internal fluid filled cavities of the at least one transfer mount and the isolator plug.

7. The pressure transmitter of claim 6, wherein the non-metallic material of the pedestal comprises alumina.

8. The pressure transmitter of claim 6, wherein the at least one isolation diaphragm is diffusion bonded to the at least one pedestal to form a non-metallic assembly.

9. The pressure transmitter of claim 8, wherein the at least one pedestal of the non-metallic assembly is soldered, brazed or glassed to the at least one transfer mount.

10. The pressure transmitter of claim 8, wherein the at least one pedestal further comprises a groove that faces the at least one transfer mount and is configured to receive a gasket, wherein the gasket is configured to prevent wetting between the non-metallic assembly and the at least one transfer mount.

11. The pressure transmitter of claim 1, further comprising at least one spacer configured to link the at least one transfer mount to the isolator plug, wherein the at least one spacer comprises an internal fluid filled cavity that is in fluid communication with the internal fluid filled cavities of the pedestal, the at least one transfer mount and the isolator plug.

12. The pressure transmitter of claim 11, wherein the spacer is laser welded to the isolator plug and wherein the at least one transfer mount includes a projection feature used for projection welding or soldering of the at least one transfer mount to the at least one spacer.

13. The pressure transmitter of claim 1, wherein the process pressure sensor comprises a gage pressure sensor and the pressure transmitter comprises an in-line pressure transmitter or the process pressure sensor comprises a differential pressure sensor and the pressure transmitter comprises a differential pressure transmitter.

14. A pressure transmitter comprising:
a process connector configured to mount to a process vessel that carries a process fluid;
a process pressure sensor;
an isolator plug coupled to the process connector and configured to house the process pressure sensor, wherein the isolator plug includes an internal fluid filled cavity that is in fluidic contact with the process pressure sensor;
a transfer mount made of a metallic material and being coupled to the isolator plug, wherein the transfer mount includes an internal fluid filled cavity that is in fluid communication with the internal fluid filled cavity of the isolator plug; and
a non-metallic assembly coupled to the transfer mount and includes a pedestal made of a non-metallic material and an isolation diaphragm made of a non-metallic material that is exposed to the process fluid in the process connector and coupled to the pedestal, wherein the pedestal comprises an internal fluid filled cavity that is in fluid communication with the internal fluid filled cavities of the transfer mount and the isolator plug.

15. The pressure transmitter of claim 14, wherein the metallic material of the transfer mount includes a coefficient of thermal expansion that comprises a range of values that overlap with a range of values of a coefficient of thermal expansion of the non-metallic assembly.

16. The pressure transmitter of claim 14, wherein the non-metallic material of the pedestal comprises alumina and the non-metallic material of the isolation diaphragm comprises sapphire.

17. The pressure transmitter of claim 14, further comprising a spacer configured to link the transfer mount to the isolator plug, wherein the spacer comprises an internal fluid filled cavity that is in fluid communication with the internal fluid filled cavities of the pedestal, the transfer mount and the isolator plug.

18. The pressure transmitter of claim 14, wherein the pedestal further comprises a groove that faces the transfer mount and is configured to receive a gasket, wherein the gasket is configured to prevent wetting between the non-metallic assembly and the transfer mount.

19. The pressure transmitter of claim 14, further comprising a gasket between the process connector and the non-metallic assembly that is configured to prevent a breach of the internal fluid filled cavity of the isolator plug and configured to prevent gasket creep.

20. A pressure transmitter comprising:
a process connector configured to mount to a process vessel that carries a process fluid;
a process pressure sensor;
an isolator plug coupled to the process connector and configured to house the process pressure sensor, wherein the isolator plug includes an internal fluid filled cavity that is in fluidic contact with the process pressure sensor;
a spacer coupled to the isolator plug and comprises an internal fluid filled cavity that is in fluid communication with the internal fluid filled cavity of the isolator plug;
a transfer mount made of a metallic material and being coupled to the spacer, wherein the transfer mount includes an internal fluid filled cavity that is in fluid communication with the internal fluid filled cavities of the spacer and the isolator plug; and
a non-metallic assembly coupled to the transfer mount and includes a pedestal made of a non-metallic material and an isolation diaphragm made of a non-metallic material that is exposed to the process fluid in the process connector and coupled to the pedestal, wherein the pedestal comprises an internal fluid filled cavity that is in fluid communication with the internal fluid filled cavities of the transfer mount, the spacer and the isolator plug.

21. The pressure transmitter of claim 19, wherein the pedestal further comprises a groove that faces the transfer mount and is configured to receive a gasket, wherein the gasket is configured to prevent wetting between the non-metallic assembly and the transfer mount.
